(19) United States
(12) Patent Application Publication
(10) Pub. No.: US 2013/0076694 A1
(43) Pub. Date: Mar. 28, 2013

(54) APPARATUS FOR DETECTING POSITION BY INFRARED RAYS AND TOUCH PANEL USING THE SAME

(71) Applicant: SHANG-TAI YEH, Taipei City (TW)

(72) Inventor: SHANG-TAI YEH, Taipei City (TW)

(73) Assignee: EGALAX_EMPIA TECHNOLOGY INC., Taipei City (TW)

(21) Appl. No.: 13/477,118

(22) Filed: May 22, 2012

(30) Foreign Application Priority Data
Sep. 26, 2011 (TW) 100134490

(51) Int. Cl. G06F 3/042; G01J 1/42

(52) U.S. Cl. 345/175; 356/51; 250/336.1

(57) ABSTRACT

An apparatus for detecting a position by infrared rays is disclosed. The apparatus includes a plurality of IR sources, a plurality of receivers and a processor electrically coupled to the receivers. The IR sources and the receivers are interlacedly configured along a frame. The IR sources emit IR signals in at least two dimensions, and the IR sources in each dimension comprise two sets of IR signals running contrarily in direction. The receivers receive the IR signals from the corresponding IR sources. Even if the IR signals in one direction of one dimension are subject to interference, the IR signals in the other direction of the dimension can still be measured by the corresponding receivers. When at least one object is set in at least one position within the frame, the processor determines the position according to the coordinates of the receivers and strength variations of the received IR signals.

### BACKGROUND OF THE INVENTION

1. Field of the Invention

The present invention relates to an apparatus for detecting a position, and more particularly, to an apparatus for detecting a position by infrared rays and a touch panel using the same.

2. Description of the Prior Art

Current touch panels, based on the technologies used, can be categorized into resistive touch panels, capacitive touch panels, ultrasonic touch panels and infrared touch panels etc. A capacitive touch panel is typically manufactured by coating an Antimony Tin Oxide (ATO) film and silver lines on a glass substrate; the advantages of which are high stability, good transmittance, and high surface hardness, but at the same time it comes at a higher cost and a more complicated manufacturing process. A resistive touch panel is typically formed by an Indium Tin Oxide (ITO) film and a sheet of ITO glass; the advantages of which are lower manufacturing cost, simpler structure, but the transmittance and surface hardness are poorer than those of the capacitive type. Ultrasonic touch panels obtain the coordinates of a position being detected by emitting ultrasound and calculating received signal strengths. Infrared touch panels utilize the principle of light shielding, in other words, infrared emitters and receivers are provided around a display screen; when an object touches the screen, it will shield the infrared signals, and by analyzing the signals received by the receivers, the coordinates of the object on the screen can be determined.

FIG. 1 is a traditional apparatus for detecting a position 100 used in an infrared touch panel. The apparatus includes a rectangular frame 110, infrared (IR) sources 101˜124 and receivers 131˜154. The receivers 131˜142 are used to receive lights emitted by the IR sources 101˜112, respectively, while the receivers 143˜142 are used to receive lights emitted by the IR sources 113˜124, respectively. When a finger or another object 120 is placed at a position inside the frame 110 such that infrared rays are shielded as shown, the receivers 135 and 136 will not be able to receive lights emitted by the sources 105 and 106, and the receivers 147 and 148 will not be able to receive lights emitted by the sources 117 and 118. The positions of the receivers 135 and 136 can determine the X coordinate of the object 120 in the frame 110, while the positions of the receivers 147 and 148 can determine the Y coordinate of the object 120 in the frame 110.

The structure of the apparatus for detecting a position 100 shown in FIG. 1 is arranged in a way so that two perpendicular sides of the rectangle are provided with the light sources, while the other two sides are provided with the corresponding receivers, thereby allowing the detection of the coordinates of an object within the frame. When the receivers 131˜142 or 143˜154 are interfered by lights, then the measurement of the X or Y coordinate by the structure shown in FIG. 1 will become inaccurate.

Therefore, there is a need to provide an apparatus for detecting a position by infrared rays, which is capable of detecting the position of an object on the panel while some signals are subject to interference.

### SUMMARY OF THE INVENTION

In view of the above prior art, in order to meet the needs of the industry, the present invention provides an apparatus for detecting a position. The main characteristic is in that when some signals are subject to interference, the position of an object on a panel can still be measured.

Accordingly, the present invention discloses an apparatus for detecting a position by infrared rays. The apparatus includes a plurality of IR sources, a plurality of receivers and a processor. The IR sources and the receivers are interlacedly configured along a frame. The IR sources transmit IR signals in at least two dimensions, and the IR sources in each dimension comprise two sets of IR signals running contrarily in direction. The receivers receive the IR signals from the corresponding IR sources. Even if the IR signals in one direction of one dimension are subject to interference, the IR signals in the other direction of the dimension can still be measured by the corresponding receivers. The processor is electrically coupled to the receivers. When at least one object is set in at least one position within the frame, the processor determines the position according to the coordinates of the receivers and strength variations of the received IR signals.

The present invention also discloses a touch panel, which includes a display screen for displaying images and said apparatus for detecting a position by infrared rays provided on the display screen, wherein the processor is used for establishing a corresponding relationship between each location of the images displayed on the display screen and each position in the frame.

The above description is only an outline of the technical schemes of the present invention. Preferred embodiments of the present invention are provided below in conjunction with the attached drawings to enable one with ordinary skill in the art to better understand said and other objectives, features and advantages of the present invention and to make the present invention accordingly.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram depicting the structure of a traditional apparatus for detecting a position by infrared rays;

FIGS. 2, 5, 6, 7 and 8 are schematic diagrams depicting embodiments of an apparatus for detecting a position by infrared rays proposed by the present invention; and

FIGS. 3 and 4 are schematic diagrams depicting an embodiment of a touch panel proposed by the present invention.

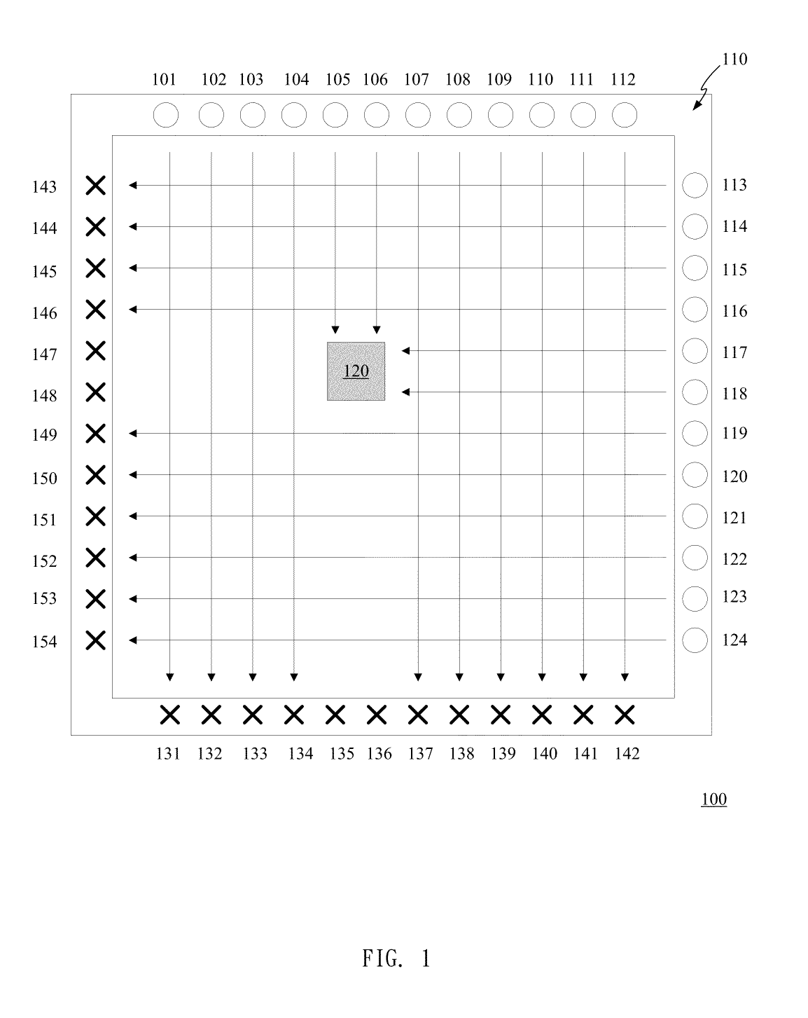

### DETAILED DESCRIPTION OF THE PREFERRED EMBODIMENTS

The present invention is directed to an apparatus for detecting a position by infrared rays and a touch panel using the same. In order to fully understand the present invention, comprehensive steps and compositions are proposed in the following descriptions. It is apparent that the implementations of the present invention are not limited to those specific details known to those skilled in the art of an apparatus for detecting a position by infrared rays and a touch panel using the same. On the other hand, well-known compositions or steps are not described in details in order not to unnecessarily impose restrictions on the present invention. Preferred embodiments of the present invention will be described below, however, in addition to these detailed descriptions, the present invention can be generally applied to other embodiments, and the scope of the present invention is not limited to these; rather, it is defined by the following claims.

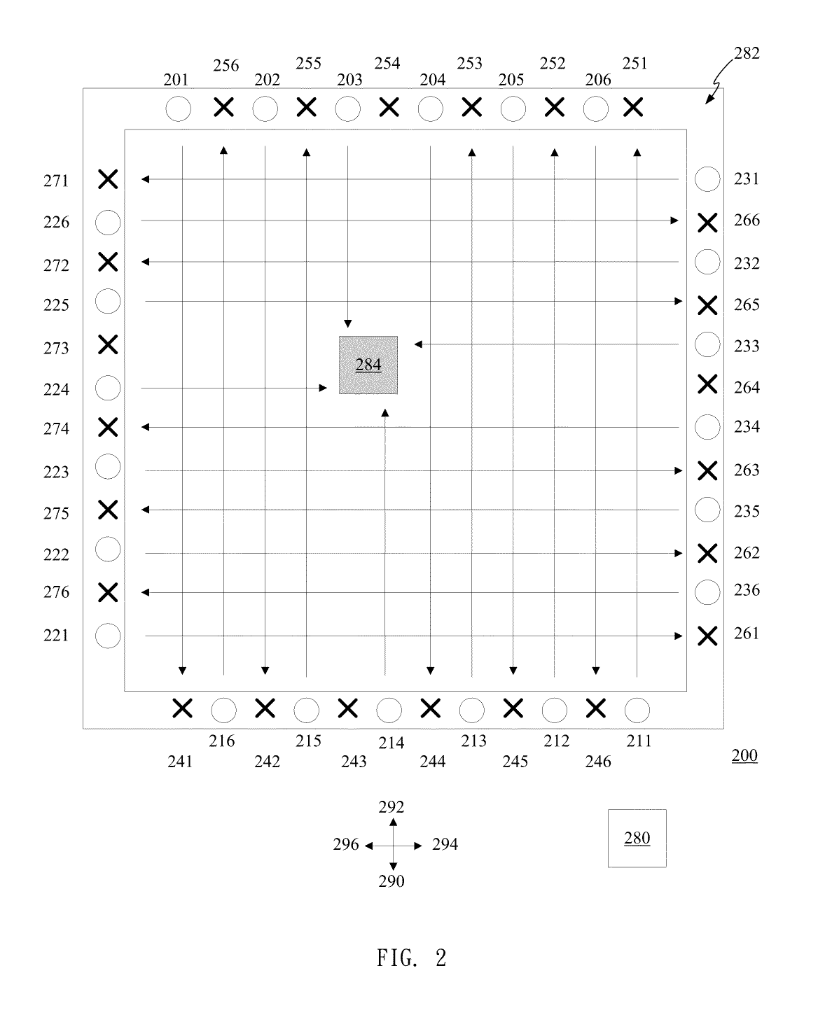

The present invention discloses an apparatus for detecting a position, in that when some signals are subject to interference, the position of an object on a panel can still be measured. With reference to the descriptions of the preferred embodiments below in conjunction with FIGS. 2 to 8, the objectives, embodiments, characteristics and advantages of the present invention will become apparent. However, the devices, elements, and steps described in the following embodiments are merely used to illustrate the present invention; they are in no way limit the present invention.

FIG. 2 is a preferred embodiment of an apparatus for detecting a position by infrared rays 200 proposed by the present invention. As s shown in FIG. 2, the apparatus for detecting a position by infrared rays 200 includes a plurality of infrared (IR) sources 201˜236, a plurality of receivers 241˜276 and a processor 280, wherein the plurality of IR sources 201˜236 and the plurality of receivers 241˜276 are arranged interlacedly along a rectangular frame.

The plurality of IR sources 201˜236 emits IR signals in at least two dimensions, and the IR signals in each dimension comprising two sets of IR signals running contrarily in direction. As shown in FIG. 2, the at least two dimension includes a first dimension and a second dimension, wherein the first dimension includes a first direction 290 and a second direction 292 opposite to each other, and the second dimension includes a third direction 294 and a fourth direction 296 opposite to each other. The plurality of receivers 241˜276 receive the IR signals transmitted by the corresponding IR sources 201˜236.

In other words, the IR sources 201˜206 and the receivers 241˜246 transmit and receive IR signals in the first direction 290, respectively; the IR sources 211˜216 and the receivers 251˜256 transmit and receive IR signals in the second direction 292, respectively; the IR sources 221˜226 and the receivers 261˜266 transmit and receive IR signals in the third direction 294, respectively; and the IR sources 231˜236 and the receivers 271˜276 transmit and receive IR signals in the fourth direction 296, respectively. In this embodiment, the IR sources 201˜236 and the receivers 241˜276 are alternately provided one next to the other. The IR signals in the two dimensions are perpendicular to each other.

The processor 280 is electrically coupled to the receivers 241˜276, wherein when at least one object 284 is placed in a position within a frame 282, the processor 280 determines the position (i.e. the coordinates) of the object 284 according to the coordinates of the receivers 241˜276 and strength variations of the IR signals received by the receivers 241˜276.

As shown in FIG. 2, when the object (e.g. a finger) 284 is placed at a position within the frame 282, the IR signals emitted by the IR sources 203,214,224 and 233 are shield by the object 284, so that they cannot be received by the receivers 243, 254, 264 and 273. The processor 280 may detect that the strengths of the signals received by the receivers 243, 254, 264 and 273 have decreased, and determine the position of the object 284 in the frame 282 based on intersections formed by two sets of connecting lines between the receivers 243, 254, 264 and 273 and their corresponding IR sources 203, 214, 224 and 233.

The processor 280 is indirectly coupled to the receivers 241˜276 for analyzing the strengths of the signals received by every receiver and calculating a specific position of an object within the frame 282. The generations of the two sets of connecting lines shown in FIG. 2 above and their intersections can be performed by a specific algorithm. Depending on actual needs, the processor 280 can be used in conjunction with an A/D converter or other well-known circuits for processing the received signals.

In IR signals in any dimension, when IR signals in a direction is subject to interference, IR signals in the other direction may still be measured by corresponding receivers. For example, if the receivers 241˜246 are interfered by electromagnetic waves or lights, such that they cannot receive IR signals in the first direction 290, IR signals in the second direction 292 can still be received by the receivers 251˜256, as a result, the coordinate of the object 284 in the first dimension may still be measured. Similarly, if receivers in one direction of the second dimension are subject to interference, receivers in the other direction may still be used to detect the coordinate of the object in the second dimension.

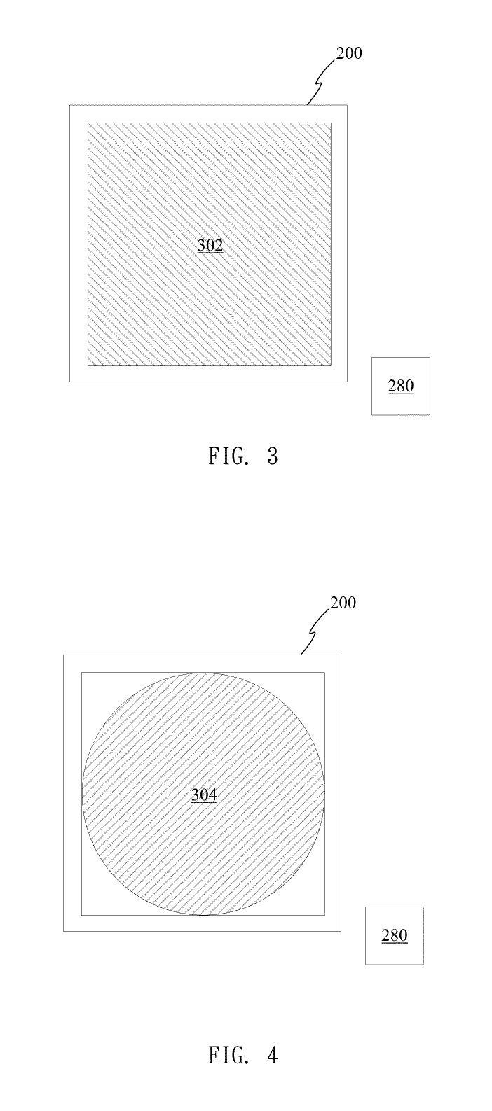

FIG. 3 is a touch panel 300 using the above apparatus for detecting a position by infrared rays 200. In the embodiment shown in FIG. 3, the apparatus for detecting a position by infrared rays 200 is disposed on a rectangular display screen 302. The processor 280 can establish corresponding relationships between surface locations (or locations where images are displayed by the screen) and positions in the apparatus for detecting a position by infrared rays 200. Thus, by obtaining a position of an object in the apparatus for detecting a position by infrared rays 200, which portion of the images to be clicked or selected can be determined. In another embodiment, the apparatus for detecting a position by infrared rays 200 can be used with a non-rectangular display screen 304, as long as the screen 304 is included in the range detectable by the apparatus for detecting a position by infrared rays 200; the shape of the screen 304 is thus not limited. FIG. 4 depicts an embodiment in which the screen 304 is a circular screen.

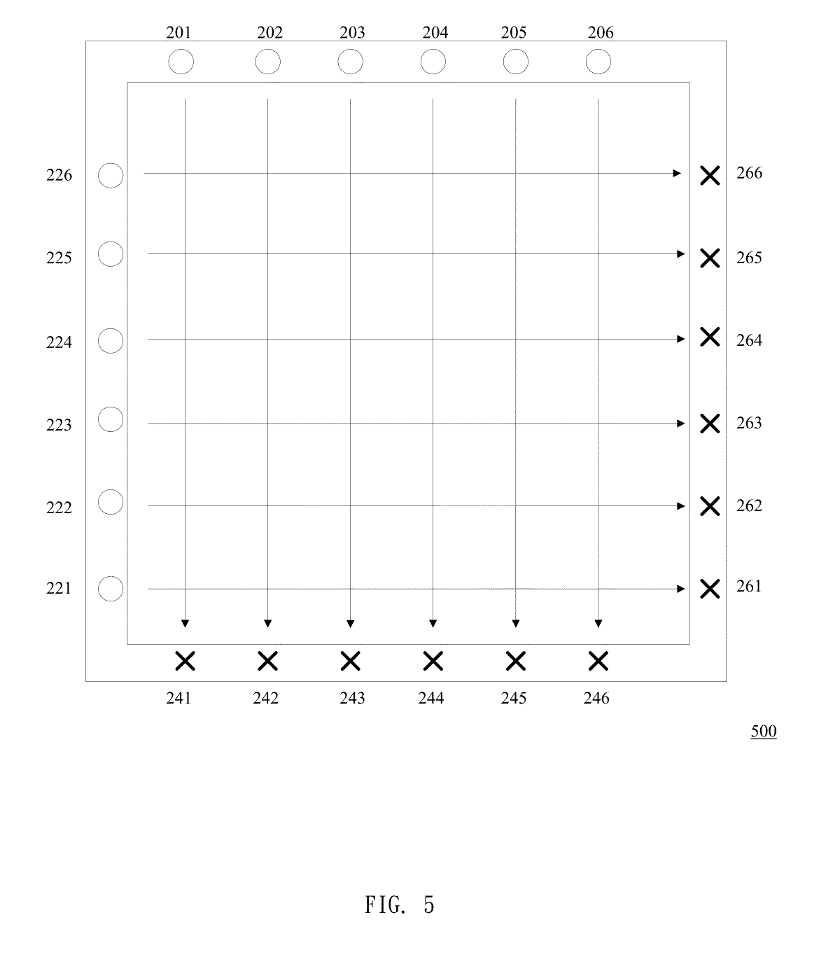

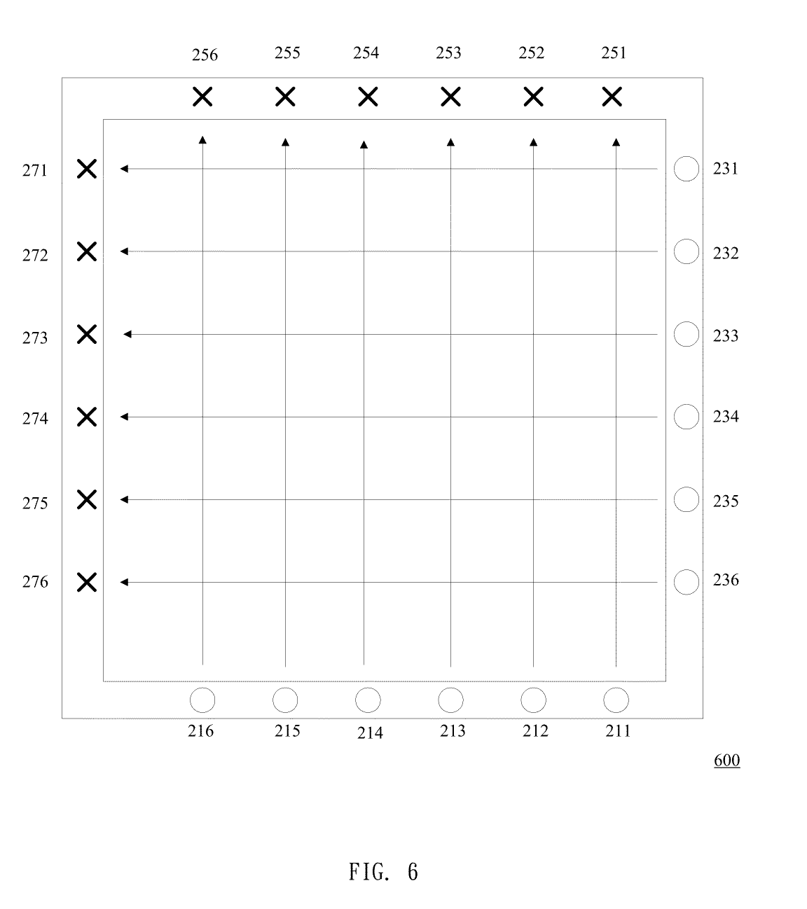

FIGS. 5 and 6 illustrate another preferred embodiment of the present invention. In order to facilitate understanding, FIGS. 5 and 6 are shown in perspective view, wherein FIG. 5 is a top perspective view, and FIG. 6 is a bottom perspective view. This embodiment disposes the IR sources 201˜206 for transmitting the IR signals in the first direction 290, the receivers 241˜246 for receiving the IR signals in the first direction 290, the IR sources 221˜226 for transmitting the IR signals in the third direction 294 and the receivers 261˜266 for receiving the IR signals in the third direction 294 in FIG. 2 on a first horizontal plane 500, as shown in FIG. 5. Moreover, this embodiment also disposes the IR sources 211˜216 for transmitting the IR signals in the second direction 292, the receivers 251˜256 for receiving the IR signals in the second direction 292, the IR sources 231˜236 for transmitting the IR signals in the fourth direction 296 and the receivers 271˜276 for receiving the IR signals in the fourth direction 296 in FIG. 2 on a second horizontal plane 600, as shown in FIG. 6.

According to the present invention, the first horizontal plane 500 and the second horizontal plane 600 are only required to be on different planes, and are not limited to the top surface or bottom surface of the frame. Thus, the first horizontal plane 500 and the second horizontal plane 600 are separated by a distance, which must be smaller than the object 284, so that the object 284 may simultaneously shield the IR signals in both dimensions.

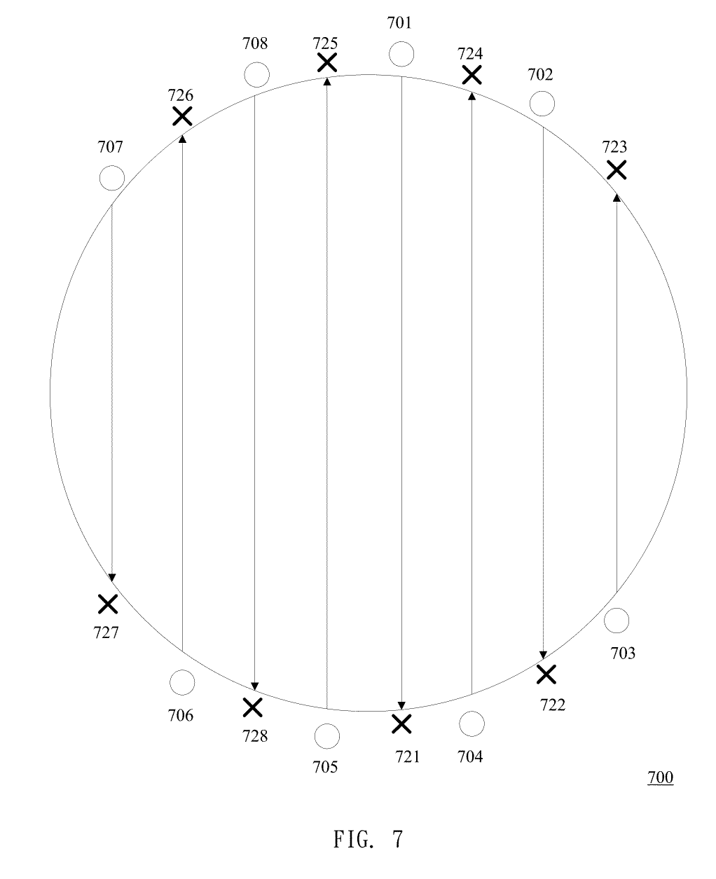

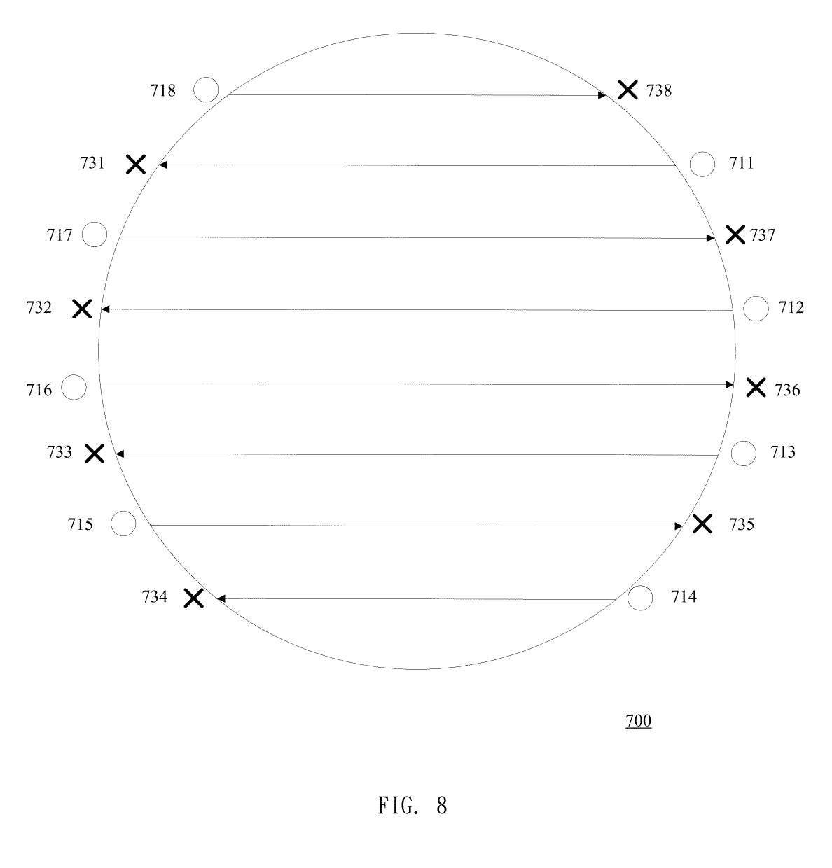

The present invention is also applicable to a circular frame as shown in FIGS. 7 and 8, wherein FIG. 7 is a top perspective view, and FIG. 8 is a bottom perspective view. As shown in FIG. 7, an apparatus for detecting a position by infrared rays 700 includes a plurality of IR sources 701˜708 and a plurality of receivers 721˜728, and the plurality of IR sources 701˜708 and the plurality of receivers 721˜728 are provided on a first horizontal plane, wherein the IR sources 701˜708 and the receivers 721˜728 are configured along the circular frame and alternating one with the other. The IR sources 701˜708 transmit IR signals in a first dimension, and the receivers 721˜728 receive the IR signals transmitted by the corresponding IR sources.

Furthermore, as shown in FIG. 8, the apparatus for detecting a position by infrared rays 700 further includes a plurality of IR sources 711˜718 and a plurality of receivers 731˜738, and the plurality of IR sources 711˜718 and the plurality of receivers 731˜738 are provided on a second horizontal plane, wherein the IR sources 711˜718 and the receivers 731˜738 are configured along the circular frame and alternating one with the other. The IR sources 711˜718 transmit IR signals in a second dimension, and the receivers 731˜738 receive the IR signals transmitted by the corresponding IR sources. In this embodiment, the IR signals in the first and second dimensions are perpendicular to each other. As noted before, the first and second horizontal planes are not limited to being on the top or bottom surfaces of the frame. Thus, the first horizontal plane and the second horizontal plane are separated by a distance, which must be smaller than the object, so that the object may simultaneously shield the IR signals in both dimensions.

It should be understood that the apparatus for detecting a position by infrared rays 700 may further include a processor for coupling to the receivers 721˜738, wherein when at least one object is placed in a position within the circular frame, the processor can determine the position (i.e. the coordinates) of the object according to the coordinates of the receivers 721˜738 and strength variations of the IR signals received by the receivers 721˜738.

Similarly, the present invention may also construct the above apparatus for detecting a position by infrared rays onto an elliptical frame; details of which will not be further described. In addition, the amounts of the IR sources and the receivers as well as the way in which they are interlaced can be different based on different resolution requirements. Generally speaking, the more the IR sources and the receiver, the higher the resolution. The amounts of the IR sources and the receivers shown herein are used merely to illustrate the principles of the present invention; the actual amounts will depend on the actual applications.

The present invention can be any possible arrangements and combinations of the drawings and embodiments above. Any of these arrangements and combinations should be regarded as various embodiments of the present invention, and they will not be repeated described one by one.

The above embodiments are only used to illustrate the principles of the present invention, and they should not be construed as to limit the present invention in any way. The above embodiments can be modified by those with ordinary skill in the art without departing from the scope of the present invention as defined in the following appended claims.

What is claimed is:

1. An apparatus for detecting a position by infrared (IR) rays, comprising:
a plurality of IR sources configured along a frame for transmitting IR signals in at least two dimensions, and the IR signals in each dimension comprising two sets of IR signals running contrarily in direction;
a plurality of receivers interlacedly configured with the plurality of IR sources for receiving the IR signals from the corresponding IR sources, wherein when the IR signals in one direction of one dimension are subject to interference, the IR signals in the other direction of the dimension are still measured by the corresponding receivers; and
a processor electrically coupled to the receivers, wherein when at least one object is set in at least one position within the frame, the processor determines the position according to the coordinates of the receivers and strength variations of the received IR signals.

2. The apparatus of claim 1, wherein the shape of the frame and the resolution of the apparatus determine the way in which the plurality of IR sources and the plurality of receivers are configured.

3. The apparatus of claim 1, wherein the plurality of IR sources and the plurality of receivers are configured one next to the other.

4. The apparatus of claim 1, wherein the IR signals in at least two dimensions are orthogonal to each other.

5. The apparatus of claim 1, wherein the shape of the frame includes rectangle, circle or ellipse.

6. The apparatus of claim 1, wherein the at least two dimensions include a first dimension and a second dimension, and the first dimension includes a first direction and a second direction contrarily in direction, the second dimension includes a third direction and a fourth direction contrarily in direction, wherein the IR source and the receiver for respectively transmitting and receiving the IR signals in the first and the third directions are on a first horizontal plane, and the IR source and the receiver for respectively transmitting and receiving the IR signals in the second and the fourth directions are on a second horizontal plane.

7. The apparatus of claim 6, wherein the first horizontal plane is separated from the second horizontal plane by a distance, and the thickness of the distance is less than the thickness of the object.

8. The apparatus of claim 1, wherein the at least two dimensions include a first dimension and a second dimension, wherein the IR source and the receiver for respectively transmitting and receiving the IR signals in the first dimension are on a first horizontal plane, and the IR source and the receiver for respectively transmitting and receiving the IR signals in the second dimension are on a second horizontal plane.

9. The apparatus of claim 8, wherein the first horizontal plane is separated from the second horizontal plane by a distance, and the thickness of the distance is less than the thickness of the object.

10. A touch panel, comprising:
a display screen for displaying images; and
the apparatus for detecting a position by infrared rays of claim 1 provided on the display screen, wherein the processor is used for establishing a corresponding relationship between each location of the images displayed on the display screen and each position in the frame.
